(19) United States
(12) Patent Application Publication
(10) Pub. No.: US 2015/0128582 A1
(43) Pub. Date: May 14, 2015

(54) ONE-WAY PLATE AND STATOR SUPPORT STRUCTURE FOR TORQUE CONVERTER USING SAME

(71) Applicant: EXEDY CORPORATION, Neyagawa-shi, Osaka (JP)

(72) Inventors: Takeshi Kawamoto, Neyagawa-shi (JP); Ken Mototsune, Neyagawa-shi (JP)

(21) Appl. No.: 14/410,831

(22) PCT Filed: Aug. 5, 2013
(86) PCT No.: PCT/JP2013/071128

§ 371 Date: Dec. 23, 2014

(30) Foreign Application Priority Data
Aug. 7, 2012 (JP) 2012-174733

(51) Int. Cl. F16D 41/12; F16H 41/24

(52) U.S. Cl. CPC F16D 41/12; F16H 41/24; F16H 2041/246
USPC 60/345

(57) ABSTRACT

A stator support structure supports a stator of a torque converter on a stationary shaft, and includes an inner race and an annular one-way plate. The inner race is coupled to the stationary shaft to be non-rotatable relative thereto, and has a plurality of protrusions on the outer peripheral surface thereof. The annular one-way plate is mounted to the inner peripheral surface of the stator to be non-rotatable relative thereto, and has a plurality of pawls. The pawls are configured to prevent relative rotation between the stator and the inner race by making contact with first end surfaces formed as one rotation-directional end surfaces of the plural protrusions when the stator is rotated in a first direction. The pawls are configured to allow relative rotation between the stator and the inner race by elastically deforming in a radial direction to climb over the protrusions when the stator is rotated in a second direction.

### CROSS-REFERENCE TO RELATED APPLICATIONS

This application is a U.S. National stage application of International Application No. PCT/JP2013/071128, filed Aug. 5, 2013, which claims priority to Japanese Patent Application No. 2012-174733, filed in Japan on Aug. 7, 2012, the entire contents of which are hereby incorporated by reference.

### BACKGROUND

1. Field of Invention

The present invention relates to a one-way plate to be used for restriction in a rotational direction. Further, the present invention relates to a stator support structure for coupling a stator of a torque converter to a stationary shaft with use of the one-way plate.

2. Background Information

A torque converter is a device that includes an impeller, a turbine and a stator in the interior thereof and is configured to transmit power through fluid in the interior thereof. In the torque converter, the stator regulates the direction of the fluid flowing from the turbine to the impeller. As a result, a large torque ratio is obtained when the impeller is rotated at a high speed and the turbine is rotated at a low speed. On the other hand, the torque ratio is reduced as the rotational speeds of the both components become close to each other.

In general, the stator is composed of an annular stator carrier and a plurality of blades fixed to the outer periphery of the stator carrier. Further, the fluid hits the concave surfaces of the blades of the stator until the rotational speed of the turbine becomes close to that of the impeller. At this time, rotation of the stator is prevented. When the rotational speed of the turbine reaches a high speed and the fluid contacts the rear surfaces (i.e., convex surfaces) of the blades, the flow of the fluid varies and resistance is increased. Thus, rotation of the stator is configured to be allowed for eliminating resistance.

As described above, a one-way clutch is used for preventing or allowing rotation of the stator in accordance with the flow direction of the fluid. A generally well-known one-way clutch is composed of an inner race, an outer race and an engaging member. The inner race is coupled to a stationary shaft. The outer race is fixed to the inner peripheral part of the stator carrier by means of press-fitting or so forth. The engaging member is made in the form of a ratchet pawl, a roller or so forth disposed between the both races.

Further, a stator support structure as described in Japanese Laid-open Patent Application Publication No. JP-A-H11-2303 has been provided for achieving reduction in axial size thereof. In the structure described in Japanese Laid-open Patent Application Publication No. JP-A-H11-2303, a pair of axially opposed surfaces is formed, and a one-way clutch is disposed between the surfaces.

### SUMMARY

The structure described in Japanese Laid-open Patent Application Publication No. JP-A-H11-2303 can achieve reduction in axial size thereof. However, the structure could not have implemented reduction in the number of components. Further, the structure cannot achieve reduction in the radial size thereof.

It is an object of the present invention to achieve reduction in the number of components and reduction in the radial size in a structure for supporting a stator.

A stator support structure for a torque converter according to a first aspect of the present invention is a structure for supporting a stator of the torque converter on a stationary shaft, and includes an inner race and an annular one-way plate. The inner race is coupled to the stationary shaft to be non-rotatable relative thereto and has a plurality of protrusions on an outer peripheral surface thereof. The annular one-way plate is mounted to an inner peripheral surface of the stator to be non-rotatable relative thereto and has a plurality of pawls. The pawls are configured to prevent relative rotation between the stator and the inner race by making contact with first end surfaces formed as one rotation-directional end surfaces of the protrusions when the stator is rotated in a first direction, and is configured to allow relative rotation between the stator and the inner race by elastically deforming in a radial direction to climb over the protrusions when the stator is rotated in a second direction.

The one-way plate is herein mounted between the stator and the inner race. The one-way plate has the plurality of pawls. Further, when the stator is rotated in the first direction, the plurality of pawls contact the first end surfaces of the plurality of protrusions formed on the inner race, and relative rotation between the stator and the inner race is prevented. Contrarily, when the stator is rotated in the second direction, the plurality of pawls elastically deform to climb over the plurality of protrusions. Thus, relative rotation between the stator and the inner race is allowed.

With use of the one-way plate thus structured, rotation of the stator can be restricted by a single component. Further, the radial dimension can be reduced. Yet further, the one-way plate can be formed by sheet metal working. Hence, required costs can be lowered.

A stator support structure for a torque converter according to a second aspect of the present invention relates to the stator support structure according to the first aspect, and wherein the pawls are formed at a predetermined width in a middle part of an axial width of the one-way plate while one rotation-directional ends thereof are cut out of the middle part to have a shape bent down to an inner peripheral side.

The plurality of pawls can be herein formed by sheet metal working of a single plate. Thus, manufacturing costs can be lowered.

A stator support structure for a torque converter according to a third aspect of the present invention relates to the stator support structure according to the first or second aspect, and wherein the stator has a plurality of recesses on an inner peripheral surface thereof, and the one-way plate has a plurality of anti-rotation pawls having a shape bent radially outward to be engaged with the recesses.

The one-way plate is herein required to be mounted to the stator to be non-rotatable relative thereto. To cope with this, in the stator support structure according to the third aspect, the anti-rotation pawls are formed by partially bending the one-way plate radially outward, and are structured to be engaged with the recesses formed on the inner peripheral surface of the stator.

The anti-rotation pawls are herein formed by sheet metal working of the one-way plate. Thus, manufacturing costs can be lowered.

A stator support structure for a torque converter according to a fourth aspect of the present invention relates to the stator support structure according to the third aspect, and wherein the anti-rotation pawls are formed on both axial ends of the one-way plate to be opposed to each other.

A one-way plate according to a fifth aspect of the present invention includes an annular plate body, a plurality of first pawls and a plurality of second pawls. The annular plate body has a predetermined width in an axial direction. The first pawls are formed in a middle part of an axial width of the plate body and are circumferentially aligned at predetermined intervals. Circumferential end sides of the first pawls have a shape bent to an inner peripheral side and are elastically deformable. The second pawls are formed in an axial end of the plate body and are circumferentially aligned at predetermined intervals. Circumferential end sides of the second pawls have a shape bent to an outer peripheral side.

According to the present invention as described above, it is possible to achieve reduction in the number of components and reduction in the radial size in a structure for supporting a stator. Further, it is possible to provide a one-way plate functioning as a one-way clutch at a low cost.

### BRIEF DESCRIPTION OF THE DRAWINGS

FIG. 1 is a cross-sectional structural view of a stator support structure according to an exemplary embodiment of the present invention.

FIG. 2 is a partial enlarged view of a one-way plate and an inner race.

FIG. 3 is a front view of the one-way plate.

FIG. 4 is a cross-sectional view of FIG. 3 taken along a line IV-IV.

### DESCRIPTION OF EXEMPLARY EMBODIMENTS

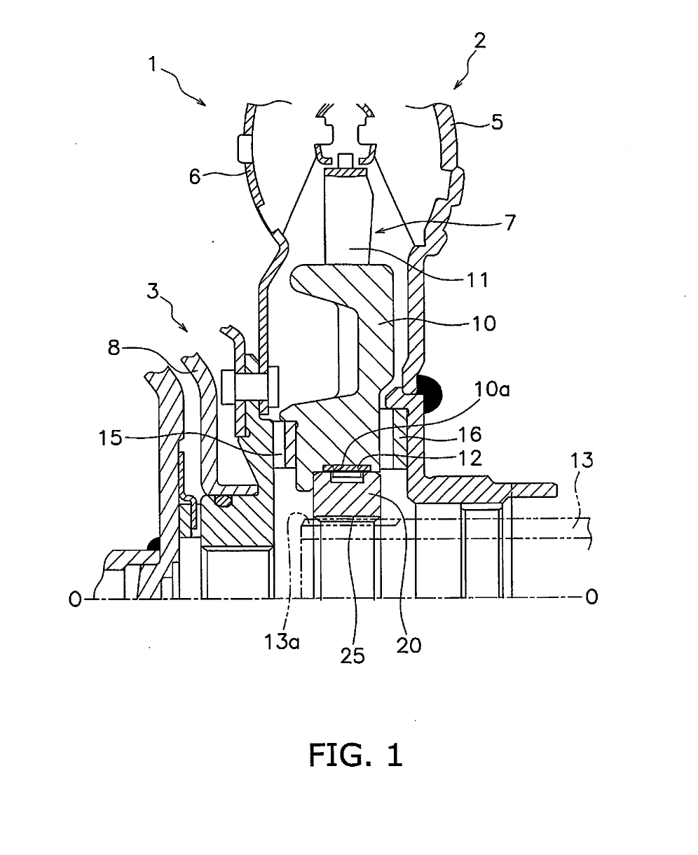

FIG. 1 partially illustrates a torque converter employing a stator support structure according to an exemplary embodiment of the present invention. A line O-O herein indicates a rotational center line.

Structure of Torque Converter

A torque converter 1 includes a torque converter body 2 and a lock-up clutch 3 (only partially illustrated). The torque converter body 2 includes an impeller 5 and a turbine 6 disposed in opposition to each other, and a stator 7. Further, the lock-up clutch 3 includes a piston 8 and so forth.

The stator 7 is a mechanism disposed between the inner peripheral part of the impeller 5 and that of the turbine 6 to regulate the flow of operating oil returning to the impeller 5 from the turbine 6. The stator 7 is mainly composed of a disc-shaped stator carrier 10 and a plurality of stator blades 11 mounted to the outer peripheral surface of the stator carrier 10. The stator carrier 10 is coupled to a stationary shaft 13 through a one-way plate 12. It should be noted that a thrust washer 15 is mounted between the turbine 6 and the stator carrier 10, whereas a thrust washer 16 is mounted between the stator carrier 10 and the impeller 5.

Stator Support Structure

Explanation will be made for a support structure for supporting the stator 7 on the stationary shaft 13. The stator support structure includes an inner race 20 and the one-way plate 12.

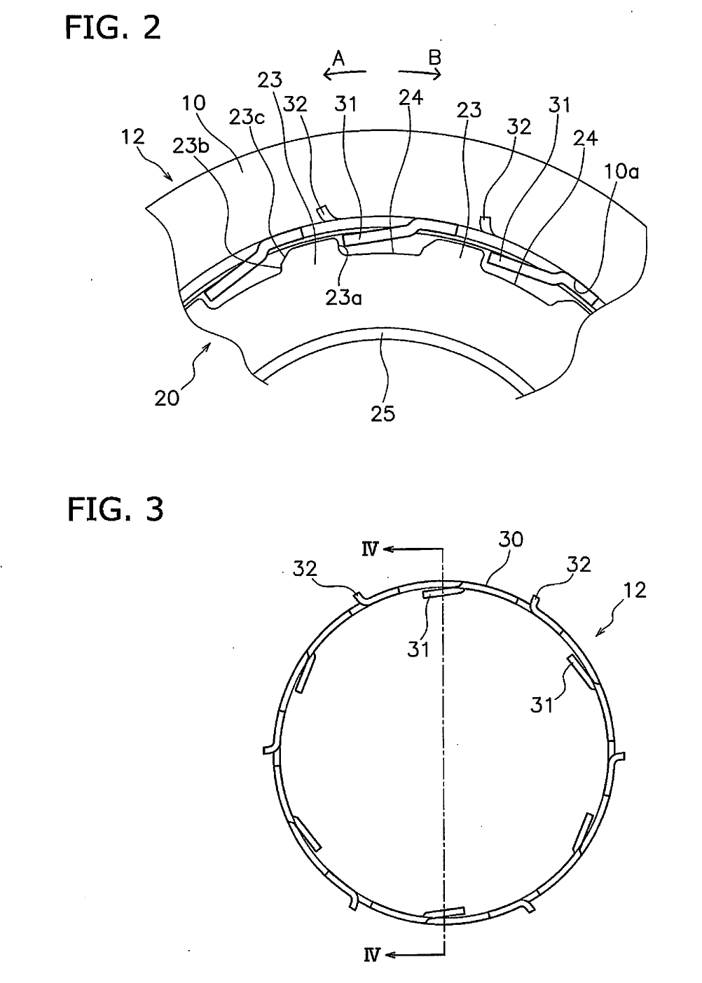

As illustrated in FIG. 1 and FIG. 2 (partially illustrating FIG. 1), the inner race 20 is an annular member. A plurality of protrusions 23 are formed on the outer peripheral surface of the inner race 20. In other words, not only the plural protrusions 23 but also recesses 24, each of which is formed between adjacent two of the protrusions 23, are formed on the outer peripheral surface of the inner race 20. First end surfaces 23a of the respective protrusions 23 are formed on an upstream side in a rotational direction, and extend substantially radially. Second end surfaces 23b of the respective protrusions 23 are formed on the opposite side, and each has a slope 23c on the outer peripheral corner thereof.

Further, the inner race 20 has a spline hole 25 formed on the inner peripheral surface thereof. The stationary shaft 13 has a spline shaft 13a formed on the outer peripheral surface thereof. The spline shaft 13a is coupled to the spline hole 25 of the inner race 20.

The one-way plate 12 is disposed on the inner peripheral surface of the stator carrier 10. More specifically, an annular groove 10a, having a predetermined width in the axial direction, is formed on the inner peripheral surface of the stator carrier 10. The one-way plate 12 is inserted into the annular groove 10a. Further, deeper grooves are formed partially in the annular groove 10a, and anti-rotation pawls (to be described) of the one-way plate 12 are engaged with the deeper grooves. Therefore, the one-way plate 12 is prevented from rotating relative to the stator carrier 10.

Detailed Structure of One-Way Plate

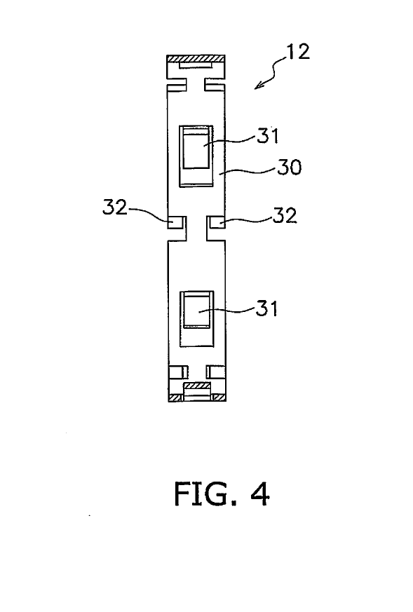

FIGS. 3 and 4 illustrate the one-way plate 12 in detail. FIG. 4 is a cross-sectional view of FIG. 3 taken along a line IV-IV.

The one-way plate 12 is formed by annularly connecting a strap plate by means of welding or so forth. The one-way plate 12 has a plate body 30, a plurality of one-way pawls (first pawls) 31 and a plurality of anti-rotation pawls (second pawls) 32. The respective types of pawls 31 and 32 are formed at predetermined intervals in the circumferential direction.

The plate body 30 has a predetermined width in the axial direction, and has an annular shape as described above.

Each one-way pawl 31 is formed by partially cutting out the middle part of the axial width of the plate body 30 and bending one circumferential end of the cut-out part to the inner peripheral side. As illustrated in FIG. 2, the one-way pawls 31 are respectively inserted into the recesses 24 of the inner race 20, and the circumferential tips thereof are contactable to the first end surfaces 23a of the protrusions 23. Further, the one-way pawls 31 are elastically deformable in a radially outward direction.

Each pair of anti-rotation pawls 32 is disposed between two one-way pawls 31 in the circumferential direction. Each pair of anti-rotation pawls 32 is disposed on both axial ends of the plate body 30 to be opposed to each other, and is formed by bending one circumferential end thereof to the outer peripheral side. Then, the anti-rotation pawls 32 are engaged with the grooves formed on the inner peripheral surface of the stator carrier 10.

Actions

When the impeller 5 is rotated at a high speed whereas the turbine 6 is rotated at a low speed, fluid collides with the concave surfaces of the blades 11 of the stator 7. Thus, the stator carrier 10 receives rotational force in an arrow A direction depicted in FIG. 2. In this case, the one-way pawls 31 of the one-way plate 12 mounted to the stator carrier 10 make contact with the first end surfaces 23a of the protrusions 23 of the inner race 20. The inner race 20 is coupled to the stationary shaft 13, and consequently, rotation of the stator 7 is prevented. Thus, the direction of the fluid flowing from the turbine 6 to the impeller 5 is regulated by the stator 7, and a large torque ratio can be obtained.

Next, when the rotational speed of the turbine 6 gradually becomes close to that of the impeller 5, the fluid flowing from the turbine 6 comes to hit the rear surfaces of the blades 11 of the stator 7. Accordingly, the stator carrier 10 receives rotational force in an arrow B direction depicted in FIG. 2. In this case, the one-way pawls 31 of the one-way plate 12 climb on the slopes 23c formed on the second end surfaces of the protrusions 23, and elastically deform radially outward. The one-way pawls 31 climb over the protrusions 23, and the stator carrier 10 is allowed to rotate relative to the inner race 20. Thus, rotation of the stator 7 is allowed, and resistance by the blades 11 can be inhibited from acting on the fluid returning to the impeller 5 from the turbine 6.

Features

The function of a well-known one-way clutch is implemented only with the inner race 20 and the one-way plate 12. Thus, the number of components can be reduced in comparison with a well-known structure.

The one-way plate 12 can be manufactured by shaping a single strap plate, and thus, the cost thereof can be lowered.

A radial dimension can be reduced, and thus, compactness in the radial direction can be particularly implemented.

With appropriate settings of the depth of the recesses 24 of the inner race 20 and the dimension of the one-way pawls 31, it is possible to avoid a situation that the tips of the one-way pawls 31 collide with the bottom surfaces of the recesses 24 after the one-way pawls 31 climb over the protrusions 23. In other words, when the stator 7 is allowed to rotate relative to the inner race 20, the one-way pawls 31 can be inhibited from producing collision sounds.

Other Exemplary Embodiments

The present invention is not limited to the aforementioned exemplary embodiment, and a variety of changes or modifications can be made without departing from the scope of the present invention.

The structure for fixing the one-way plate 12 to the inner surface of the stator carrier is not limited to that described in the aforementioned exemplary embodiment. Further, the dimensions of the respective components are also illustrative only.

Likewise, the specific shapes and arrangements of the one-way pawls 31 and the anti-rotation pawls 32 are not limited to those described in the aforementioned exemplary embodiment.

In the stator support structure for a torque converter according to exemplary embodiments of the present invention, the number of components can be reduced and a reduction in radial size can be achieved. Further, it is possible to provide a one-way plate functioning as a one-way clutch at a low cost.

1. A stator support structure for a torque converter, the stator support structure supporting a stator of the torque converter on a stationary shaft, the stator support structure comprising:
an inner race coupled to the stationary shaft to be non-rotatable relative thereto and having a plurality of protrusions on an outer peripheral surface thereof; and
an annular one-way plate mounted to an inner peripheral surface of the stator to be non-rotatable relative thereto and having a plurality of pawls, wherein
the plurality of pawls are configured to prevent relative rotation between the stator and the inner race by making contact with first end surfaces formed as one rotation-directional end surfaces of the protrusions when the stator is rotated in a first direction, the plurality of pawls being configured to allow relative rotation between the stator and the inner race by elastically deforming in a radial direction to climb over the protrusions when the stator is rotated in a second direction.

2. The stator support structure for a torque converter recited in claim 1, wherein
the plurality of pawls are formed at a predetermined width in a middle part of an axial width of the one-way plate while one rotation-directional ends thereof are cut out of the middle part to have a shape bent down to an inner peripheral side.

3. The stator support structure for a torque converter recited in claim 1, wherein
the stator has a plurality of recesses on an inner peripheral surface thereof, and
the one-way plate has a plurality of anti-rotation pawls, the plurality of anti-rotation pawls having a shape bent radially outward to be engaged with the plurality of recesses.

4. The stator support structure for a torque converter recited in claim 3, wherein
the plurality of anti-rotation pawls are formed on both axial ends of the one-way plate to be opposed to each other.

5. A one-way plate, comprising:
an annular plate body having a predetermined width in an axial direction;
a plurality of first pawls formed in a middle part of an axial width of the plate body and circumferentially aligned at predetermined intervals, circumferential end sides of the first pawls having a shape bent to an inner peripheral side and being elastically deformable; and
a plurality of second pawls being formed in an axial end of the plate body and circumferentially aligned at predetermined intervals, circumferential end sides of the second pawls having a shape bent to an outer peripheral side.

6. The stator support structure for a torque converter recited in claim 2, wherein
the stator has a plurality of recesses on an inner peripheral surface thereof, and
the one-way plate has a plurality of anti-rotation pawls, the plurality of anti-rotation pawls having a shape bent radially outward to be engaged with the plurality of recesses.

7. The stator support structure for a torque converter recited in claim 6, wherein
the plurality of anti-rotation pawls are formed on both axial ends of the one-way plate to be opposed to each other.
